(19) United States
(12) Patent Application Publication
(10) Pub. No.: US 2011/0123054 A1
(43) Pub. Date: May 26, 2011

(54) METHOD AND SYSTEM FOR DETERMINING RELATIVE POSITIONS OF MULTIPLE LOUDSPEAKERS IN A SPACE

(75) Inventors: Alan Brock ADAMSON, Greenbank (CA); Stefan Roman HLIBOWICKI, Scarborough (CA)

(73) Assignee: ADAMSON SYSTEMS ENGINEERING INC., Port Perry (CA)

(21) Appl. No.: 12/950,640

(22) Filed: Nov. 19, 2010

Related U.S. Application Data
(60) Provisional application No. 61/262,711, filed on Nov. 19, 2009.

(51) Int. Cl. H04R 5/02

(52) U.S. Cl. 381/300

(57) ABSTRACT

A method for identifying and recording the relative positions of loudspeakers in an array with respect to one another using amplifiers connected on a network.

### CROSS REFERENCE TO RELATED U.S APPLICATION

This patent application relates to, and claims the priority benefit from, U.S. Provisional Patent Application Ser. No. 61/262,711, filed on Nov. 19, 2009, which is incorporated herein by reference in its entirety.

### FIELD OF THE INVENTION

The present invention relates to a method and a system for determining the relative spatial positions of networked loudspeakers joined together in an array, using amplifiers, signal processing, software, computers and network devices by means of software controlled electro-acoustic communication between the loudspeakers.

### BACKGROUND OF THE INVENTION

### The Array

Large arrays of full frequency range loudspeakers have been the standard for producing high sound pressure levels for concerts production and performance installation demanding high fidelity for many years. Both large and small sound systems for commercial uses are found in movie theatres, board rooms, universities, night clubs, race tracks, stadiums and houses of worship to name but a few applications. Such systems are commonly used to amplify an audio signal derived from a live performance or a recorded source that is controlled by an operator using an audio mixing system called a live audio mixing console. The console is followed by a wide array of electronic equipment that results in the amplified audio signals radiating from arrays of loudspeakers directed toward an audience.

In the early days of professional audio, loudspeaker array designers directed sound three dimensionally from clusters of loudspeakers, known as spherical arrays. Since the turn of the millennium, vertical rows of low frequency transducers have been arranged symmetrically on either side of a centrally oriented vertical slot energized by high frequency transducers and in some cases flanked by two parallel rows of slots energized by mid frequency transducers. This has become known as the line array.

### The Array Element

Each loudspeaker assembly may comprise audio transducers, enclosures which define volumes of air for related low and mid frequency transducers, horns or wave shaping sound chambers and related transducers, rigging hardware, amplifiers, heat sinks, digital signal processing hardware or networking hardware or some combination of these components. Since these assemblies are then joined together to form an array of the desired geometry, functionality and performance, they are now frequently called array elements.

A loudspeaker array can be characterized as any assembly of loudspeaker array elements containing at least two array elements. In both commercial and home systems the vast majority of amplifiers have been separate from the loudspeaker, although in the past decade it is becoming more common to see the power amplifier mounted in the loudspeaker.

### Conventional Wiring Configuration

In all systems each loudspeaker enclosure must have at least one amplifier channel directing its power audio signal to it. The method of connection of these loudspeaker elements to their respective amplifiers is by use of electrical wire.

In professional audio these wires transmit significant amounts of power and are sized accordingly. In a large array, the bundles of wire can be quite large and represent a limiting factor with respect to material cost, labor for assembly and even architectural weight restrictions. The result of these limitations is that fewer wires will be configured to transmit power to the array and a number of array elements will be connected together in a daisy chain.

In simplified arrays such as this the electrical information (power audio signal) being sent to each loudspeaker is not unique, and an interchange of wires form one array element to another is of little consequence. However a means of ensuring that the correct relationship between loudspeaker, signal and power amplifier channel is generally employed for purposes of trouble-shooting.

The wire is usually encoded with color or a number which informs the person assembling the group of speakers with the amplifiers of the correct electrical relationship between the amplifiers and the loudspeakers.

### Networked Audio

Historically, audio signals have been analog from the very small voltages developed by a microphone, to the kilowatts of power delivered to the loudspeakers. As digital audio gained ground, hybrid systems comprising analog mixing consoles followed by digital signal processors followed by analog amplifiers became common. Further gains in digital audio have seen the mixing console change to a digital device and the near elimination of analog devices in the signal chain. However, such systems still bear a strong resemblance to analog systems in that the signal is still carried in dedicated wiring.

In recent years, digital audio systems have begun to resemble IT (information technology) systems. With the advent of computers, DSP and standardized digital audio encoded signals, a number of methods based on ideas taken from the computer networking have been devised for distributing digital audio signals, transmitting system control data and gathering performance information from the operation of the system via communication between the endpoint and a host computer and/or DSP. The incorporation of computers in such networks allows complete control of the behavior of the audio system.

The cables and electronics comprising this type of network connectivity are mostly derived from the communications industry. Such interconnected loudspeakers are referred to as networked systems. These methods are somewhat like office or home networks, but with the added ability to stream high quality uninterrupted audio and control data to the chosen device.

The network devices found in such systems can comprise electronic network communications components such as gateways, switches and endpoints. A gateway is a networking device configured to introduce an audio signal into a network. An endpoint is a networking device placed at a destination for an audio signal, comprising electronics similar to a computer network interface card (NIC). A networking device is configured to forward a signal and thus distribute it further is called a switch.

Audio devices may comprise amplifiers, digital signal processor (DSP) based or passive crossovers and equalizers as well as speakers. Crossovers are frequency dividing networks that divide the audio spectrum into bands of energy suitably matched in frequency to the requirements of audio transducers. Crossovers and equalizers may also be comprised of passive or active analog electrical components. Amplifiers, equalizers and loudspeakers are well known in the field of the invention.

As is common in the communications industry, whether an office network or an internet, many possible configurations can be realized for any network application. The same is true of audio networks.

### Network Configurations

One network professional audio configuration is to place all the amplifiers in an amplifier rack in a location near the loudspeaker array. The DSP required to process the audio signal is mounted either within the amplifier racks, remotely from the amplifiers, or combined within the amplifier. A network endpoint associated with the DSP receives the networked encoded audio and control signals and passes them to the DSP which performs the audio processing according to the instructions found in the control signal and passes the output audio signal to the amplifiers. The amplified power audio signal is fed from the amplifiers to the array via multi-conductor wires. In these configurations specifically differing signals may be generated by DSP and therefore the resulting power audio signals from the associated amplifiers must be sent to the exact required destination array element. The correct relationship between the network signal and the transducers in the array must be maintained.

Another network configuration is to mount the network endpoint, DSP and amplifiers within the array element so that each transducer receives its power audio signal, directly from the closely mounted amplifier. In this case an identical networked audio signal is fed to multiple network endpoints, each within its array element and while the audio signal may be common to all endpoints, networked control signals unique to each array element must be matched to the correct destination array element. These unique control signals instruct the DSP to compute the required crossover function, to direct the audio signal to the correct amplifier and thus the power audio signal to the correct target transducer.

Audio network configurations are not limited to the above mentioned examples. As network technology matures other possibilities will emerge. For example, a woofer has been introduced to the market that has an amplifier with DSP mounted directly on the frame of the loudspeaker.

Similar schemes are emerging by use of power over Ethernet (PoE, IEEE 802.3af-2003) with the placement of network devices mounted on the transducer.

In all of these cases control data is needed to instruct the DSP, control the endpoint and insure that the array element is performing its correct task within the array. Using the same digital communication pathway, information derived from the performance of the array element is passed back and forth on the same network cables. As well, a computer is connected to the network for management of the network.

### Control and Management

In data communications networking, the terminology used to describe the identification and management of devices on a network includes discovery, enumeration, naming and management. First compatible devices need to be found and then enumerated. The devices may then be named to make them easier to deal with conceptually and they are thus available for management. The naming process usually associates an actual name such as “Office Printer” with an IP address. In an audio system a name might look like “Speaker #1 Stage Right Array”. Management may include reorganizing the interconnectivity (links) between devices, disabling and enabling links or adding and removing network devices. In networks MAC and IP addresses are used to identify devices. The network operator has little, if any, control over the assignment of the addresses, since some are pre-assigned at the time hardware manufacture and some are assigned automatically when a device is placed in a network.

In a large commercial audio application, loudspeaker arrays can be very large, typically in the order of several tons, and thus inaccessible when they are put in place for use. Complete systems with hundreds of elements are common in large performance spaces and public buildings. In very large events such as the Olympic Games, thousands of devices may be networked. In some cases arrays may be separated by great distances rendering them out of practical access. Many of these elements are identical in their technical specifications and are used in multiples. This presents a particular problem for the technicians setting up and controlling such a system.

### Lots of DPS Generated Signals

With the advent of networked DSP, the possibility exists to significantly increase the number of unique audio signals or unique control signal transmitted to the array for the purpose of improving the computation of the array function. In the case where the DSP and amplifier are disposed within the array element, it is inevitable that a unique control signal will be sent and a unique audio signal will be derived for every audio transducer in the entire array. Such a configuration allows processing of the array as a whole (array processing).

DSP computation of arrays of transducers has been common in radar and sonar applications for many years where it is used to steer a beam of energy in a calculated direction, so the mathematics is well understood. Such computation takes into account the summation of all the array elements and in particular takes great care with respect to the interactions of each adjacent transducer in the array. Recently array processing has been used in a limited number of audio applications by a small but growing number of companies. By treating the entire array as one mathematical equation and varying the time delays and equalization of each array element, extensive improvements in the quality of audio are possible in all applications.

The most significant feature of array processing is that every element in the array has a distinct mathematical relationship to all the other elements. In order to predict the outcome of the signal processing each element must be given the exact signal prescribed to it. Otherwise there will be an adverse interaction between adjacent drivers and the effort to process the complete array as a unit will be futile. An incorrect positioning of a transducer signal within the array may cause a radical equalization response or to bend (steer) part of the audio signal in space and direct it to an undesirable location.

Such a significant increase in distinct audio signals being sent to or generated in identical elements within an array, raises a significant challenge managing the connections and signals.

In a communications network by comparison, it is also critical that a network device get the information assigned to it. But the physical location of a device such as a computer is unimportant to the functioning of the network. For example a computer may be moved from one office to the next and it will still get the information sent to it. Laptop computers may receive their assigned information in an airport equally as well as at the coffee shop.

In audio network even small variations in equalization between adjacent transducers places an absolute requirement on identifying the correct sequential placement of the array elements within the array and delivering the correct audio signal to the assigned endpoint. Unlike the office network, the precise physical sequence of the array element within the array must be known.

### Oh Speaker Wherefore Art Thou?

In the configuration of an array it is common to use a specialized software program to predetermine its physical configuration prior to commencement of assembling the array. Such a software program will take into account the size and shape of the room in which the array will be installed and make its determination based on the audience coverage and the sound pressure level required. The physical configuration thus determined, will comprise the angular relationship between each array element, the desired overall angle of the array and its height from the floor (distance from the ceiling). As a consequence of this procedure, no information is required concerning the distance from one array element to the next. However the relative position of the array elements must be established.

A simplified example is that in an audio system we have a left speaker signal and we want it to go to the left speaker. It is a simple matter to connect the one loudspeaker to the left speaker cable and turn it on. If we are correct then we plug in the right channel and we have achieved our goal. Otherwise we will reverse them. In a large networked array we are required to associate the channels or the control data from the source with the correct array element by associating its address with the correct channel of audio information.

### Setup

When the arrays have been physically configured, installed and are under power it is common for technicians to employ measurement software on a management/setup computer to test and modify the performance of the arrays by making adjustments to DSP settings before use. In the most common method, a time coherent test stimulus generated by the computer energizes the transducers in the array and the resulting sound is received some time later by a microphone in the listening environment. The computer performs an autocorrelation calculation on the sent signal and the delayed received signal to determine the precise time delay. The difference between the two signals represents the transfer function of the array.

This test methodology is common in the field of the invention. One such test system (MLSSA) utilizes maximum length sequences (MLS) of pseudo-random noise as a time coherent test stimulus. Another (SMAART) uses the music signal as a time coherent signal.

Another method (TEF) uses a swept sine wave with quadrature filters to derive an impulse response. All audio test systems produce an impulse response representing the time domain performance of the device under test as well as frequency domain amplitude and phase response. Audio technicians qualified to set up a large system of arrays are commonly conversant with at least one of the measurement techniques.

### Existing Methods of Enumeration

An existing method of identifying the place of an array element within an array includes placing a rotary switch or a small electronic device on each element which is then set to a unique identification number which can be read by the management/setup computer. This method works well, but places a constraint upon the technicians setting up the arrays. Every element must be identified and placed into the array in its accorded location. Any failure to follow a strict plan will result in an element being given an incorrect signal.

Another method relies on the IP address of the endpoint which allows the operator to have a unique identifier for the array element but it does not tell the operator the relative position of the array elements within the array should the interconnectivity of the array elements not follow the same sequence as the physical sequence of the array elements.

Therefore it would be very advantageous to provide a method and system for determining the relative positions (sequential relationship) of multiple array elements in an array using the components and functions of the networked audio system. A method is required that gives the precise physical sequence of the array element within the array which avoids the aforementioned limitations, using the audio system as a whole to perform the task.

### SUMMARY OF THE INVENTION

The present invention provides a method and system for determining relative positions of multiple loudspeaker array elements in an array with respect to one another using computers, DSP, amplifiers and network connectivity components connected together forming an audio network.

An embodiment of the invention provides a method for determining relative positions of multiple array elements in at least one array located in a space, comprising the steps of:

a) broadcasting an audio signal into the space from a first position;

b) receiving the audio signal at one or more loudspeakers within an array element within the at least array;

c) calculating one or more propagation delays between broadcasting and receiving by each of the one or more array elements in the at least one array; and

d) based on the calculating, determining the relative positions of the array element in the at least one array.

Another embodiment of the invention provides a method for determining relative positions of multiple array elements in an array located in space, comprising the steps of:

a) broadcasting audio signals into the space from at least some of the array elements in said array;

b) receiving the audio signals at a microphone located in said space;

c) calculating propagation delays between broadcasting by said at least some of the array elements and the audio signals received by said microphone; and

d) based on the calculating, determining the relative positions of said at least some of the array in the array.

In another embodiment of the invention there is provided a loudspeaker array apparatus, comprising:

a) a plurality of loudspeaker array elements aligned in at least one array in a space, each loudspeaker array element including at least one loudspeaker and associated amplifiers and first transducers configured to receive audio signals;

b) a second transducer in a first position in the space configured to emit an audio signal into the space; and

c) a computer controller with a user interface connected to said first transducers of said plurality of loudspeaker array elements and to said second transducer, said computer controller programmed to calculate one or more propagation delays between said second transducer emitting an audio signal and said first transducers receiving said audio signals, said computer controller being programmed to, based on the calculated one or more propagation delays, determining the relative positions of the loudspeakers in the at least one array.

A further understanding of the functional and advantageous aspects of the invention can be realized by reference to the following detailed description and drawings.

### BRIEF DESCRIPTION OF THE DRAWINGS

The invention will now be described, by way of non-limiting examples only, reference being made to the accompanying drawings, in which:

FIG. 1a shows an isometric front view of a loudspeaker line array element;

FIG. 1b shows an isometric rear view of the loudspeaker line array element of FIG. 1a;

FIG. 2 shows the side view of a loudspeaker array comprised of eight array elements of FIGS. 1a and 1b with one of the array elements 10a depicted as emitting sound waves and propagating isotropic away from element 10a;

FIG. 3 shows the same array as FIG. 2 with sound emanating from a different randomly selected array element 10d;

FIG. 4 shows a chart of impulse responses computed by the management/setup computer using the software provided;

FIG. 5 represents the configuration if the array element with the address IP5 is at the bottom of the array;

FIG. 6 represents the pattern of impulse responses resulting from the configuration in FIG. 5;

FIG. 7 represents the configuration if the array element with the address IP5 is at the top of the array; and

FIG. 8 represents the pattern of impulse responses resulting from the configuration of FIG. 7.

FIG. 9 shows the side view of a loudspeaker array comprised of eight array elements of FIGS. 1a and 1b with a test loudspeaker depicted as emitting sound waves and propagating isotropic toward the array;

FIG. 10 represents the pattern of impulse responses resulting from the configuration in FIG. 9;

FIG. 11 shows the side view of a loudspeaker array comprised of eight array elements of FIGS. 1a and 1b with one of the array elements depicted as emitting sound waves and propagating isotropic toward a test microphone;

FIG. 12 represents the pattern of impulse responses resulting from the configuration in FIG. 11;

FIG. 13 shows the side view of two (2) loudspeaker arrays comprised of eight array elements of FIGS. 1a and 1b with both of the array elements depicted as emitting sound waves and propagating isotropic toward a test microphone; and

FIG. 14 shows a flow block diagram of the software control for the embodiment of the system shown in FIGS. 2 through 7.

### DETAILED DESCRIPTION OF THE INVENTION

Generally speaking, the embodiments described herein are directed to a method and system for determining relative positions of multiple array elements which gives the precise physical sequence of the array element within the array using loudspeakers, amplifiers, DSP, networking hardware, a computer and specialized software connected on a network. As required, embodiments of the present invention are disclosed herein. However, the disclosed embodiments are merely exemplary, and it should be understood that the invention may be embodied in many various and alternative forms. Some features may be exaggerated or minimized to show details of particular elements while related elements may have been eliminated to prevent obscuring novel aspects.

Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a method and system for determining relative positions of multiple loudspeaker elements which gives the precise physical sequence of the array element within the array using loudspeakers, amplifiers, DSP, networking hardware, a computer and specialized software connected on a network.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein the phrase “array element” or “loudspeaker array element” refers to a loudspeaker assembly which may comprise audio transducers, enclosures which define volumes of air for related low and mid frequency transducers, horns or wave shaping sound chambers and related transducers, rigging hardware, amplifiers, heat sinks, digital signal processing hardware or networking hardware or some combination of these.

As used herein the word “array” refers to at least two array elements assembled together for the purpose of reproduction of sound, capable of being energized with an audio signal.

The present invention is directed to a method and system for the discovery, enumeration, identification, naming and establishment of the spatial relationship of array elements located within an array.

The present invention employs all the elements of an assembled networked sound system to perform specific tasks not anticipated in such a system. The typical networked commercial audio system is managed by a computer which is generally attached to the system during all significant times such as during setup, maintenance and performance. The typical signal path starts with an audio signal originating at a gateway, which is routed through switches, arrives at an endpoint, is decoded and modified by DSP, sent to an amplifier and then to the transducers.

In the present invention specialized functions are implemented in two of these components. First, measurement software is devised to operate in the management/setup computer to send a test signal to an array element and to receive resulting signals from other array elements, and second, amplifiers and transducers are configured so that when a sound wave strikes the surface of a transducer, the electricity that is thereby generated can be sensed in the amplifier and returned through the network to the management/setup computer to be received in the measurement software. In this configuration a transducer can radiate sound and receive a signal from a sound wave striking the transducer at the same time. Furthermore all embodiments that are contemplated using an transducer within the array element can be realized with the addition of a dedicated microphone mounted in the array element that is configured to transmit its signal to the network with the same result as the audio transducer.

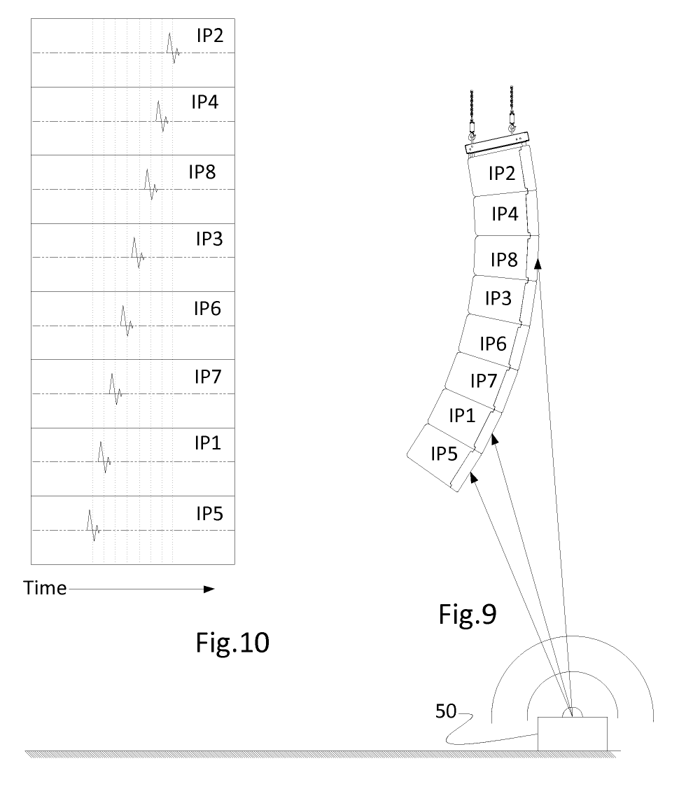

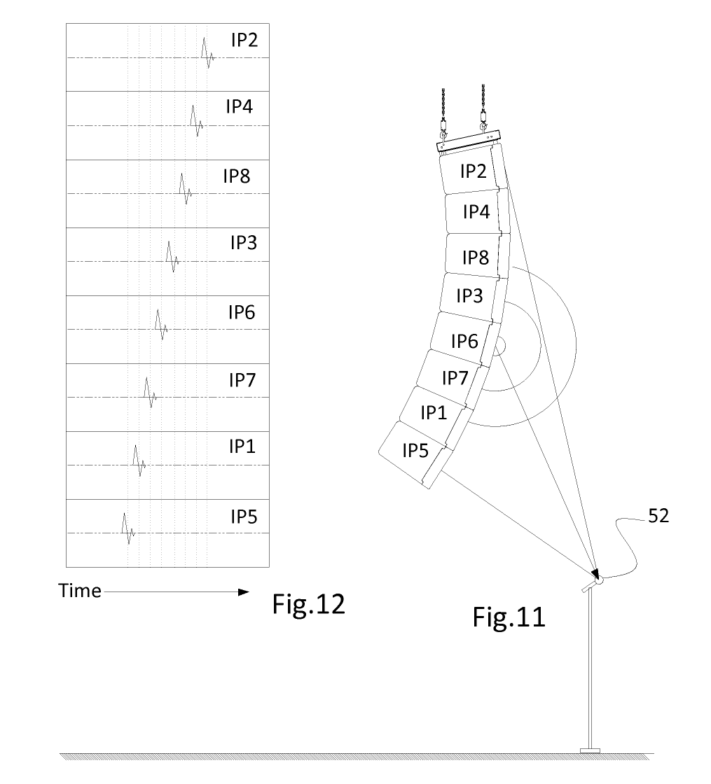

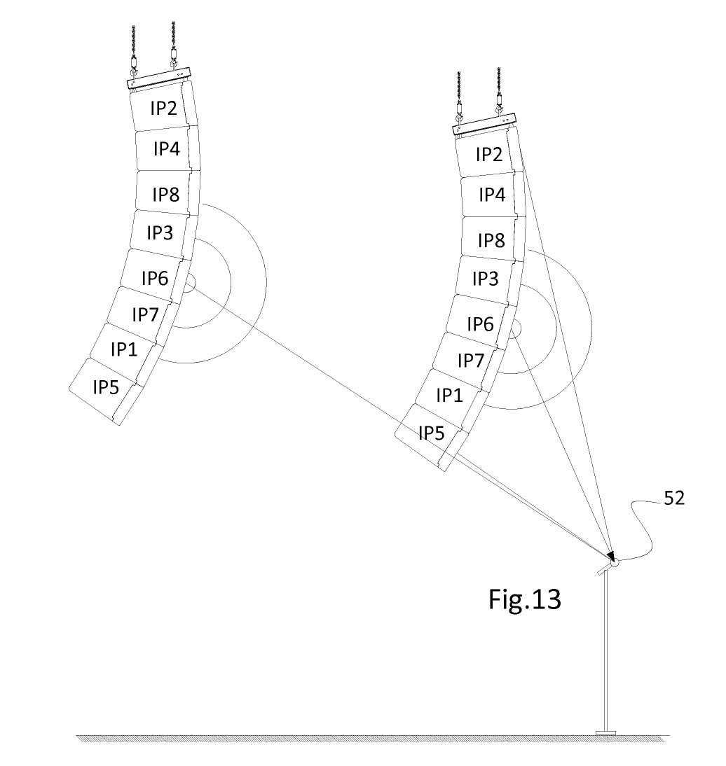

Enhancements are achieved by the addition of a microphone for receiving signals outside of the array (in embodiments shown hereafter in FIGS. 11 and 13) and/or addition of an external test loudspeaker spaced from the array to transmit test signals to the array as shown in FIG. 9 hereafter discussed and the computer being configured to include an acoustic model to assist in disambiguation of the data gathered by the computer controller.

In an embodiment of the invention the measurement software is configured such that a test signal is sent randomly to one element within an array. Typically the low frequency transducers of one array element would be used since their directivity characteristics are generally suited to radiate in an omni-directional pattern allowing sound waves to propagate down the face of the array and to come in contact with the other low frequency transducers in the array.

The corresponding transducers in all the other array elements in the array are then configured as receivers (microphones). This is achieved by monitoring current flowing in the output stage of the amplifiers that are attached to the low frequency transducers. Current is caused to flow back by the electromotive force (EMF) that is produced by the sound waves moving the loudspeaker diaphragm thus generating a voltage in the voice coil of the transducer.

Sound travels slowly through air at a rate of 344 meters per second (M/s). Considering a large line array element that might commonly be approximately 400 mm in height, the sound emitting from one array element will arrive at the transducer of the adjacent array element in approximately 1.2 milliseconds (ms). A comparison of the test stimulus impulse response sent to the first array element with the impulse returned from the adjacent array element will show the 1.2 ms time delay associated with the propagation speed of sound in air.

As the sound passes across the face of the array and each successive transducer, the impulse responses thus generated will reveal the increasing time delays associated with the sound propagation to each successive transducer.

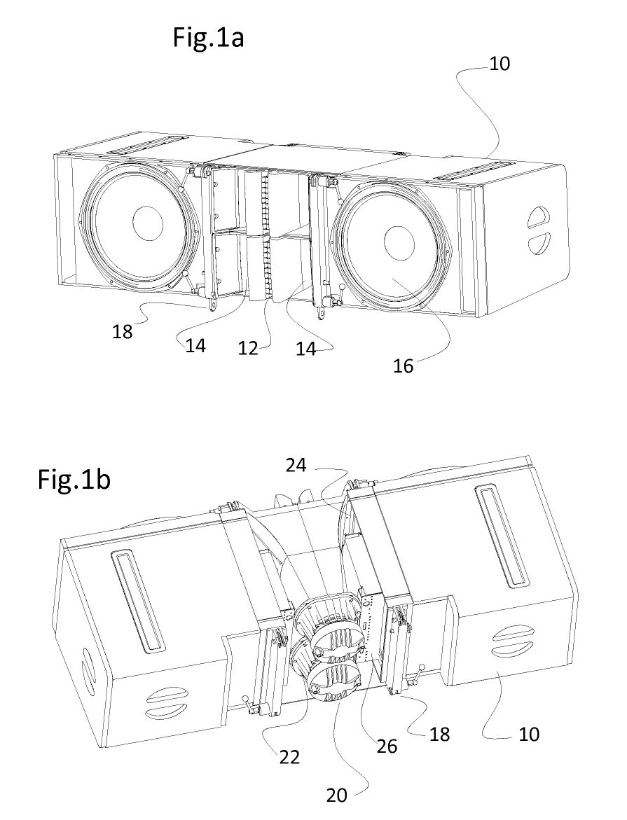

FIG. 1a shows an isometric front view of a line array element 10. The high frequency (HF) slots 12 are located at the centre of the array element 10. Parallel rows of mid frequency (MF) slots 14 are located on either side of the HF slots 12. The low frequency transducers 16 are located on either side of the MF slots 14. The speaker cones (diaphragms) 17 of the low frequency transducers 16 are direct radiating. A connection (rigging) system 18 is typically provided to join the array elements 10 together to form an array.

FIG. 1b shows an isometric rear view of a line array element 10. The high frequency (HF) transducers 20 are typically found at the rear of the array element 10. In the case of this particular array element 10 shown here, the HF transducer 20 is mounted co-axially with the mid frequency (MF) transducer 22. Space is provided 24 for the installation of electronic hardware 26.

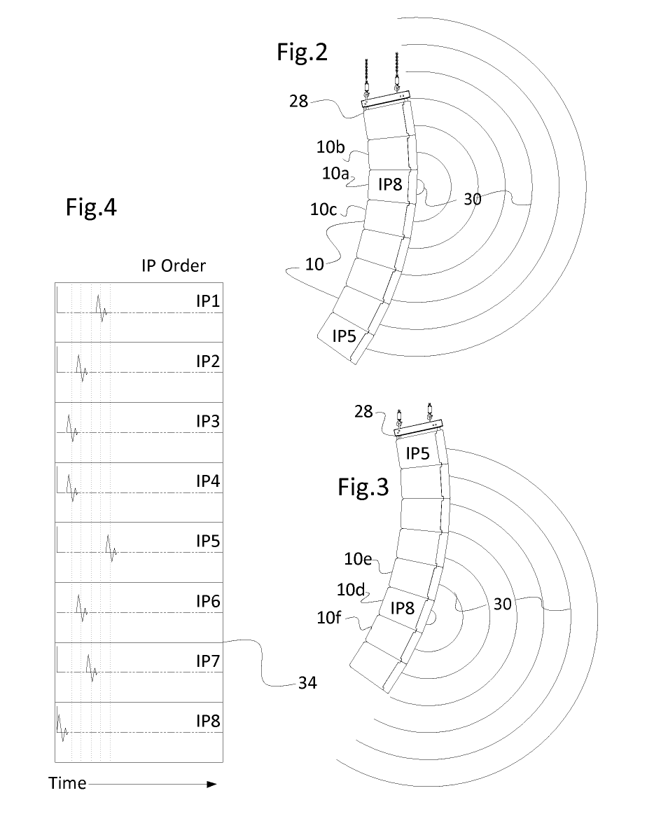

FIG. 2 shows the side view of a loudspeaker array 28 comprised of eight array elements 10. An array such as this will be connected with network and electrical power cables that are not shown for purposes of clarity. Upon powering up a networked array 28 network addresses are listed by the management/setup computer as is typical of computer networks. At this point in the setup the operator does not know the relationship between the physical array element 10 and the network address associated with that particular array element 10. Software residing in the computer is caused to generate a time coherent test signal which is sent to an array element 10 chosen at random. In FIG. 2 sound waves 30 are depicted emanating from that randomly chosen array element 10a.

FIG. 3 shows the same array 28 as in FIG. 2 but with sound emanating from a different randomly selected array element 10d which is acting as a sound radiator. In both FIG. 2 and FIG. 3 the sound radiates across the front of the array 28.

FIG. 4 shows a chart of impulse responses computed by the management/setup computer using the software provided. Amplifiers 26 within the array element 10 or amplifiers mounted in amplifier racks nearby are configured to receive an electrical signal generated by the movement of the transducer diaphragm 17 (as shown in FIG. 1a) which is configured as a sound receiver and transmit this signal through the network to the management/setup computer. The software is further configured to compute impulse responses from the signal returning from the amplifiers 26. Following that operation, the software displays the impulses for the benefit of the operator on for example, a computer screen that is part of the computer.

These impulse responses represent the earliest times of arrival possible by sound that is travelling a direct route from the sound radiator to the sound receiver. Since the adjacent transducers configured as receivers are located in close proximity to the one transducer (at address IP8) that is configured as a radiator sound, the sound will arrive reflection free. Other reflected sound waves that may originate from nearby boundaries such as a floor or wall will strike the diaphragm and create additional weaker impulses later in time.

An examination of the chart of impulse responses reveals that the time delay associated with several pairs of impulse responses are identical. This is caused for example by the equal spacing of array elements 10b and 10c on either side of the element 10a. These impulses correspond to the addresses IP3 and IP4 of FIG. 4. An additional pair of identical time delays is found at addresses IP2 and IP6. In larger arrays more identical pairs will be found. A person practiced in the art will realize that there are many possible ambiguities of this type and that a precise understanding of each possibility is of no consequence.

A more noteworthy type of ambiguity is shown in the comparison of FIG. 2 with FIG. 3. If the stimulus signal is moved from 10a FIG. 2 to array element 10d FIG. 3 the pattern of impulse responses shown in FIG. 4 matches exactly. The elements 10e and 10f could both create impulses associated with either of the impulses shown next to IP4 or IP3 address. Therefore the radiation from different array elements shown in FIG. 2 and FIG. 3 can both satisfy the impulse pattern shown in FIG. 4.

It is clear from the illustrations of FIGS. 2, 3 & 4 that several ambiguities of different types are present. Fortunately an examination of all the ambiguities serves only to show the need discovering the correct relationship between array elements and IP addresses.

FIG. 4 contains two unambiguous pieces of information. First, the impulse response opposite address IP8 shows no delay and is therefore known to be the address where the test signal originated. Secondly, the impulse associated with address IP5 has the maximum delay. The address at IP5 is therefore at one extreme end of the array, but which end is yet to be determined.

The first step in resolving the ambiguities is to move the test signal to address IP5. This illustration is based on an example and the address IP5 should not be considered absolute. In a logical sense, when the stimulus is placed at the end of the array, each of the remaining array elements can have only one unique delay associated with its physical position and its address in the array.

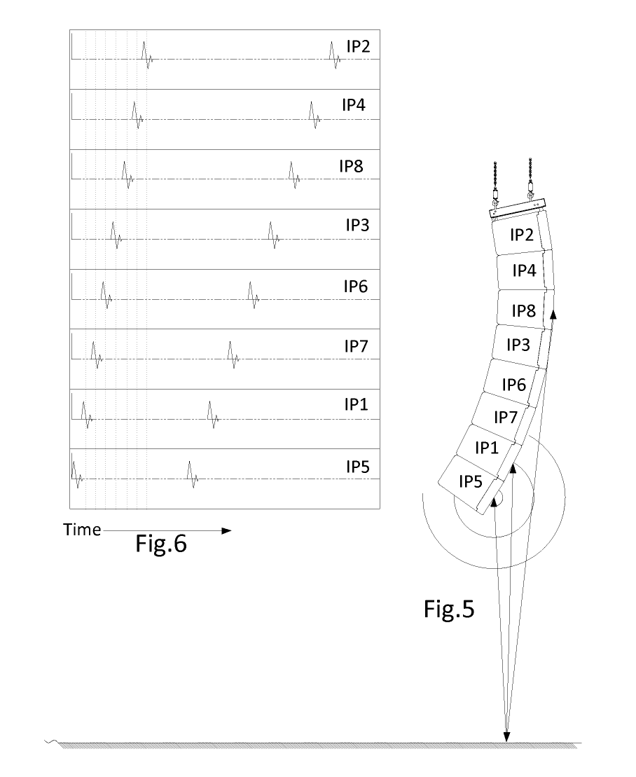

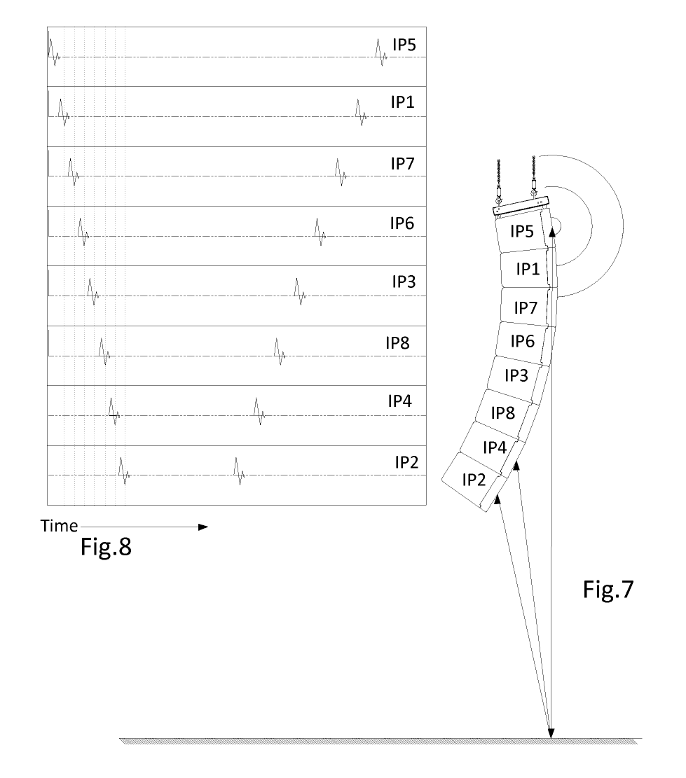

When the test stimulus is moved to the end of the array represented in this case by the address IP5 the ambiguity is reduced to the choice between FIG. 5 and FIG. 7 with the corresponding pattern of impulse responses shown in FIG. 6 and FIG. 8. In the absence of any additional information the ambiguity between the array of FIG. 5 and the array of FIG. 7 cannot be resolved.

FIG. 5 represents the configuration if the array element with the address IP5 is at the bottom of the array. FIG. 7 represents the configuration if the array element with the address IP5 is at the top of the array. However, there is no way to know whether IP5 is at the top of the array or at the bottom.

FIG. 6 shows a chart representing the pattern of impulse responses resulting from the array configuration in FIG. 5. The header of the chart indicates that the row of impulses on the left side is created by the direct sound that arrives at the receiving transducer by the shortest path. The header further indicates that the remaining impulses shown on the right side are caused by reflected sound that arrives later. In this illustration, the reflections are from the floor.

FIG. 8 represents the pattern of impulse responses resulting from the configuration of FIG. 7. The chart is configured the same as the chart in FIG. 6.

A comparison of the impulses caused by the sound reflected from the floor of FIG. 6 and FIG. 8 reveals a distinct difference.

In FIG. 5 the reflected impulse of the radiating transducer of the array element at address IP5 is quite close in time to the direct impulse at the same address. By comparison, the reflected impulse at address IP2 is significantly later in time. This is a clear indication that the array element containing the address IP5 much closer to the floor than the array element containing the address IP2. The ambiguity is thus removed and the address can be mapped to its correct signal source.

In FIG. 8 the opposite is true. The reflected impulse at IP5 is much later in time than the reflected impulse at IP2. This indicates that IP5 is at the top of the array.

The software may be further configured to reorganize the relationships between the networked loudspeaker elements to correctly represent their spatial position within the array. The randomness of the connectivity can be replaced with the correct order representing the locations of the array element within the array. After the addresses of the array elements have been matched to the physical position of the element, the software program can offer the operator an opportunity to assign names to the array element such as “Number one Stage Left” etc.

FIG. 9 represents another embodiment of the method wherein the software is configured to send a test signal to a separate loudspeaker 50 designed to radiate the test signal toward the array to thus stimulate the array elements and to receive the test signals from the array elements and to compare the received test signals to the expected result based on either the acoustical model of the array or temporal relationships between the elements. The results may be recorded in any manner that allows the reorganization of the relationships between the networked loudspeaker elements to correctly represent their spatial position within the array.

FIG. 10 represents the impulse responses gathered by the software after a single test. Since the position of the test loudspeaker 50 is known to be at the bottom of the array, an immediate calculation of the relationship between all the elements can be realized and the correct position in the array assigned to all addresses.

FIG. 11 represents another embodiment of the method wherein the software is configured to send a test signal to the elements of an array randomly and one at a time to cause the elements to emit one at a time and to receive the test signals from a test microphone and to compare the received test signals to the expected result based on the acoustical model of the array. The acoustic model mentioned above is not essential to implement the present method. The acoustical model of the array contains information as to the number of elements and its position within the acoustical environment. A comparison of the acoustical model will allow the computer to determine which impulses represent valid elements of the array and which ones might represent reflections. An acoustical model of the array will contain significant information about the array including the relative amplitudes of the impulses that would be generated by adjacent array elements. Ambiguities can therefore be quickly eliminated.

FIG. 12 represents the impulses gathered by the measurement computer. An immediate association can be made between the addresses and the physical position of the array element within the array since the position of the microphone 52 is known. The results may be recorded in any manner that allows the reorganization of the relationships between the networked loudspeaker elements to correctly represent their spatial position within the array.

FIG. 13 represents another embodiment of the method wherein the software is configured to send a test signal to the elements of more than one array within a room and to receive the test signals from more than one array and to determine the spatial relationships of the arrays based on any of the previous methods. A floor mounted microphone 52 can be used to reduce the uncertainty of the measurements. However it is possible through logical deduction to eliminate ambiguities in order to define the positions of the elements in the same manner as previously described.

Furthermore any complete acoustical model of a group of arrays contains information as to the spatial relationship of all the array elements within each array and the spatial relationship between each array. This is needed to calculate the acoustical properties of the arrays and to estimate acoustical reactions with its acoustical environment. The development of the acoustical model begins with the typical setup software (described in the background), variations of which are used by every major manufacturer of loudspeaker arrays and therefore well known in the art. A person practiced in the art will know that it is a simple matter the user to input all the physical data of the array elements and the room boundaries. Most such software at present allows an automatic calculation of the best position of all arrays and the total number of elements required based solely on the room boundaries.

Once this information is input to the system, the software can rely on this information to randomly send test signals to elements in various arrays and differentiate between elements that are closely spaced and therefore belong in the same array and elements that are far away.

In the preferred embodiment of this method a freestanding microphone 52 is used but a person practiced in the art will realize that this method can be applied to all the foregoing methods.

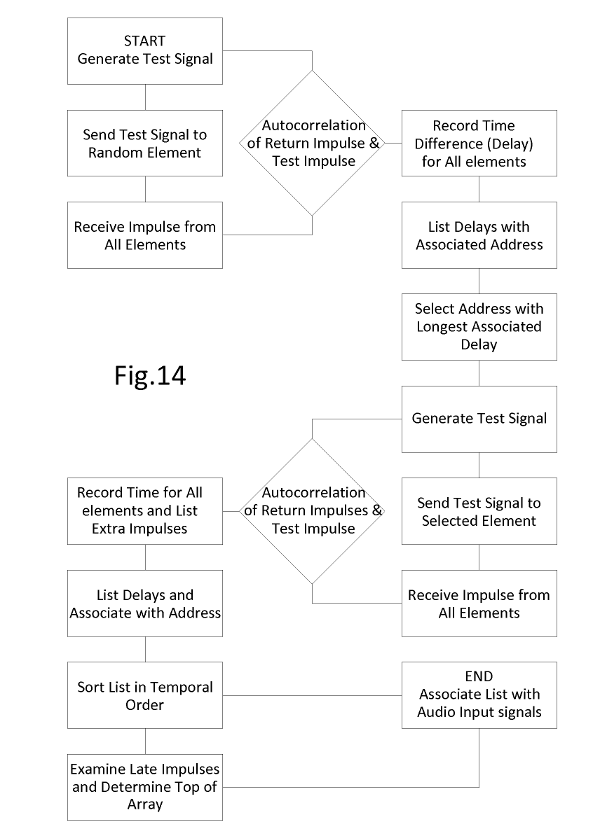

FIG. 14 shows a flow block diagram of the software control for the embodiment of the system shown in FIGS. 2 through 7. In the first step, a test signal is generated by the computer. There are many different ways to generate test signals within a computer and the particular method is of no consequence to the outcome. Nearly all audio test methods involve the computation of an impulse response, which is the basis of all time domain measurements. A representation of an impulse response is shown in FIGS. 4, 6, 8, 10 and 12. The leading edge of an impulse response is easy to identify and can be used to represent the initial time of arrival of the sound at the receiving transducer.

The impulse is sent to a randomly selected array element. Following this all transducers in the array return an electrical signal that they have generated as a result of sound from the energized transducer striking the surface of the transducers.

Impulse responses are computed from the received signals and compared to the original impulse response by autocorrelation to derive the time relationship between the signals. In this case the software is looking for seven additional impulse responses. The software may look for additional verification of the results by examining the acoustic model to compare the expected time differences with the measured time differences. This method is described in association with FIG. 13.

The longest time delay which is associated with the array element that is furthest array element from the test signal radiating transducer is chosen for the next test.

A test signal is applied to the newly selected transducer and the resulting impulses are recorded. New autocorrelations are performed between the test impulse response and the returned impulse responses. The computed time delay information is then listed with the correctly associated addresses of the array elements. The list is then sorted according to the time delay information.

The remaining function is shown in FIGS. 5 and 7, namely to determine the top or bottom of the array. In order to do this the software will examine the late arriving impulses to determine which end of the array is closer to a known reflection causing boundary surface. If this determination remains ambiguous, the software can be configured to display the results in a graphic form for inspection by the operator. The operator can manually energize an array element to make the final determination if required.

When a satisfactory determination has been achieved, the final result allows the correct association between audio signal paths and endpoints in array elements to be established.

Additional software determinations can be made with the same method as above and applied to the method shown in FIG. 13. As has been discussed an acoustical model of a complete sound system will contain information as to the acoustical and therefore physical positions of loudspeaker arrays in a proposed application.

The same steps are performed as shown in FIG. 14 with the added complexity that many impulse responses gathered will but significantly delayed since they will be generated from a greater distance form an array that might be placed on the opposite side of a room. In a case like this, the software will ignore the signals that are arriving too late to be part of the array being enumerated. This decision may be assisted by information taken from an acoustic model of the sound system. Once the focus has been reduced to the addresses that belong in a single array, the process of identification of the array being examined is completed.

The process can then be started again with another unidentified address which would be found in another unidentified array. After the identification of the elements in that array, the software can select another address until all the unidentified array elements have been found.

An alternative embodiment of the invention would include the installation of a low cost microphone or other transducer, in the face of each array element. Any other signal as might be generated to indicate the arrival of the sound waves radiating from any other source. This embodiment can be used with the methods shown in FIGS. 5, 7 and 9.

A person skilled in the art will realize that while all of the aforementioned embodiments are shown as a vertical array the all can be realized in a horizontal or a mixed horizontal and vertical array.

As used herein, the terms “about” and “approximately”, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method for determining relative positions of multiple array elements in at least one array located in a space, comprising the steps of:
a) broadcasting an audio signal into the space from a first position;
b) receiving the audio signal at one or more loudspeakers within an array element within the at least array;
c) calculating one or more propagation delays between broadcasting and receiving by each of the one or more array elements in the at least one array; and
d) based on the calculating, determining the relative positions of the array element in the at least one array.

2. The method according to claim 1, wherein the step of receiving is conducted by a loudspeaker transducer associated within each of the one or more other array elements.

3. The method according to claim 2 wherein the step of receiving the audio signal at one or more other loudspeaker transducer within an array element in the array is achieved by detecting current flowing in each output stage of each amplifier that is connected to each transducer of each of the one or more array element which occurs when sound waves impinge on the transducer.

4. The method according to claim 3, wherein the transducer is a low frequency transducer associated with the array element.

5. The method according to claim 1, wherein the step of broadcasting is conducted by a loudspeaker not located in the array and wherein said first position is spaced from said at least one array.

6. The method according to claim 1, wherein the step of broadcasting is conducted by a loudspeaker located in an array element in the at least one array.

7. The method according to claim 1, wherein the receiving is conducted by at least one auxiliary microphone associated with at least one array element.

8. The method according to claim 1, further comprising repeating the method by causing at least one loudspeaker of an array element within the array to broadcast a respective audio signal and performing the receiving, calculating and determining at least a second time.

9. The method according to claim 1, performed under computer control using a computer controller networked to each of the array elements in the array, wherein one or more amplifiers within the array element of array are configured to receive a signal generated by the movement of a diaphragm associated with each transducer and transmit this signal through the network to the computer controller.

10. The method of claim 9, wherein the computer controller includes software configured to compute impulse responses from the signal returning from the one or more amplifiers.

11. The method of claim 10 wherein the software is configured to display the impulses for the benefit of the operator on a visual display.

12. The method of claim 1 wherein the computer controller includes an acoustic model of said at least one array in the space, and wherein the software is configured to utilizes the acoustic model to clarify data gathered by the computer controller.

13. A method for determining relative positions of multiple array elements in an array located in space, comprising the steps of:
a) broadcasting audio signals into the space from at least some of the array elements in said array;
b) receiving the audio signals at a microphone located in said space;
c) calculating propagation delays between broadcasting by said at least some of the array elements and the audio signals received by said microphone; and
d) based on the calculating, determining the relative positions of said at least some of the array in the array.

14. A loudspeaker array apparatus, comprising:
a) a plurality of loudspeaker array elements aligned in at least one array in a space, each loudspeaker array element including at least one loudspeaker and associated amplifiers and first transducers configured to receive audio signals;
b) a second transducer in a first position in the space configured to emit an audio signal into the space; and
c) a computer controller with a user interface connected to said first transducers of said plurality of loudspeaker array elements and to said second transducer, said computer controller programmed to calculate one or more propagation delays between said second transducer emitting an audio signal and said first transducers receiving said audio signals, said computer controller being programmed to, based on the calculated one or more propagation delays, determining the relative positions of the loudspeakers in the at least one array.

15. The loudspeaker apparatus of claim 14, wherein first transducers are the loudspeakers themselves.

16. The loudspeaker apparatus of claim 15, wherein each loudspeaker array element includes a detection circuit configured to detect current flowing in each output stage of each amplifier that is connected to each transducer of each of the one or more loudspeakers which occurs when sound waves impinge on the transducer.

17. The loudspeaker apparatus according to claim 14, wherein first transducers are one or more auxiliary microphones each associated with a respective one of the one or more other loudspeaker array elements.

18. The loudspeaker apparatus according to claim 14, wherein the second transducer is a first transducer which is in one of the loudspeaker array elements.

19. The loudspeaker apparatus of claim 14, wherein said computer controller includes software configured to send signals to one or more of the speaker elements to cause them to emit at separate times, and including a microphone located in said space and spaced from said at least one array which is connected to said computer controller, and wherein said computer controller is programmed to calculate one or more propagation delays between said one or more of the transducers of the one or more speaker elements that are emitting an audio signal and said microphone receiving said audio signals, said computer controller being programmed to, based on the calculated one or more propagation delays, determining the relative positions of the loudspeakers in the at least one array

20. The loudspeaker apparatus according to claim 14, wherein the second transducer is a speaker spaced from said at least one array.

21. The loudspeaker apparatus according to claim 14, wherein said computer controller includes a visual display monitor for displaying the propagation delays to an operator.

22. The loudspeaker apparatus according to claim 14, wherein said at least one array is two or more arrays.

23. The loudspeaker apparatus of claim 14, wherein said computer controller includes an acoustic model of said at least one array in the space acoustic model of said space the software is configured to display utilizes the acoustic model to clarify data gathered by the computer controller.
